(19) United States
(12) Patent Application Publication
(10) Pub. No.: US 2015/0381688 A1
(43) Pub. Date: Dec. 31, 2015

(54) SYSTEM AND METHOD FOR REAL-TIME AGGREGATION OF IMAGES

(71) Applicant: Celer Images Inc., Fort Worth, TX (US)

(72) Inventors: Lawrence E. Jenkins, Fort Worth, TX (US); Irwin D. Thompson, Duncanville, TX (US); Ernest W. Cubit, Southlake, TX (US)

(21) Appl. No.: 14/750,392

(22) Filed: Jun. 25, 2015

Related U.S. Application Data
(60) Provisional application No. 62/017,346, filed on Jun. 26, 2014.

(51) Int. Cl. H04L 29/06; H04L 12/721; G06Q 20/12; G06F 17/30

(52) U.S. Cl. CPC H04L 65/602; G06F 17/30265; H04L 65/4076; H04L 45/72; G06Q 20/123; G06F 17/30203; G06F 17/30876

(57) ABSTRACT

A method, system and computer program product for embedding news agency specific information into an image data stream, including a server configured to process and route an image file according to information included in a data stream corresponding to the image file; a cloud based database configured to transmit news agency specific information; and a computer device including a software application configured to receive the news agency specific information from the cloud based database, embed the news agency specific information into the image file, and transmit the data stream corresponding to the image file to the server.

### CROSS REFERENCE TO RELATED APPLICATIONS

The present invention claims priority to U.S. Provisional Patent Application Ser. No. 62/017,346 of Jenkins et al., entitled “SYSTEM AND METHOD FOR REAL-TIME AGGREGATION OF IMAGES,” filed on Jun. 26, 2014, the entire disclosure of which is hereby incorporated by reference herein.

### BACKGROUND OF THE INVENTION

1. Field of the Invention

The present invention generally relates to systems and methods for image processing, and more particularly to a method and system for real-time aggregation of images on smart phone, applications, and the like.

2. Discussion of the Background

Currently, organizations are collecting images from multiple smartphones via email, upload to a web address, application, posting to social media, and the like. For example, in typical systems, a smartphone owner, operator, contributor, and the like, can generate an image, and then deliver the image to an organization, such as a newspaper, magazine, website, company and the like. However, such systems and methods suffer from lack of robustness and efficiency with respect to image delivery time that still require a manual process to keep track of who sent which image, and time lost in aggregation of many images in one view, and the like.

### SUMMARY OF THE INVENTION

Therefore, there is a need for a method and system that addresses the above and other problems. The above and other problems are addressed by the illustrative embodiments of the present invention, which provides a more efficient real-time process to aggregate images from multiple users of devices, such as smartphone, laptop, desk top PC, and the like, into one view that can be uploaded directly to a gallery for an organization, and with identifying information about the attached image, and the like. For example, in the news industry, the novel system and method facilitates access to contributors that are attending community news events, advantageously, while incentivizing contributors with a potential for compensation for sending images through a suitable application 401 (e.g., in Apple App Store (iOS), Android App on Google Play, etc.). A discriminator is used to identify clients in the news industry 402 and provides a purchasing platform that also enables subscribing organizations to share, purchase pictures from various contributors, and the like.

Accordingly, in illustrative aspects of the present invention there is provided a system, method, and computer program product for embedding news agency specific information into an image data stream, including a server configured to process and route an image file according to information included in a data stream corresponding to the image file; a cloud based database configured to transmit news agency specific information; and a computer device including a software application configured to receive the news agency specific information from the cloud based database, embed the news agency specific information into the image file, and transmit the data stream corresponding to the image file to the server.

The news agency specific information configured to allow tracking of a news correspondent by a news agency for submission.

The news agency specific information configured to allow automatic routing of the image file.

The news agency specific information configured to allow tracking of payment tied to amateur correspondents submissions.

The news agency specific information configured to associate information in a cloud service to an image submission.

The software application configured to allow submission by an amateur correspondent, and consolidates news gathering image capabilities.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIGS. 1A-1C are used to illustrate a system and method for real-time image aggregation, including client subscription;

FIGS. 2A-2B are used to illustrate a system and method for real-time image aggregation, including contributor targeting;

FIG. 3 is used to illustrate a system and method for real-time image aggregation, including upload of an image via an application;

FIG. 4 is used to illustrate a system and method for real-time image aggregation, including an organization viewing an image;

FIG. 5 is used to illustrate a system and method for real-time image aggregation, including purchasing of an image;

FIG. 6 is used to illustrate a system and method for real-time image aggregation, including a graphic example of marketing/advertising to potential contributors;

FIG. 7 is used to illustrate a system and method for real-time image aggregation, including a graphic example of the application downloaded on a cellular telephone;

FIG. 8 is used to illustrate a system and method for real-time image aggregation, including additional graphic examples of the application downloaded on cellular telephones;

FIG. 9 is used to illustrate a system and method for real-time image aggregation, including a graphic example of accessing the application on a cellular telephone; and

FIG. 10 is used to illustrate a system and method for real-time image aggregation, including a graphic example of using a cellular telephone to capture and upload an image.

### DETAILED DESCRIPTION OF THE PREFERRED EMBODIMENTS

The present invention includes recognition of problems associated with conventional image delivery systems and methods, including image delivery consuming time, requiring a manual process to keep track of who sent which image, and the like. In addition, with organizations in the news industry, reduction in staff photographers has resulted in the inability to cover most community news events that readers want to hear about. Furthermore, even when having a staff photographer equipped with a smartphone, and the like, the photographer still has to get to the location of most community news events, and the like.

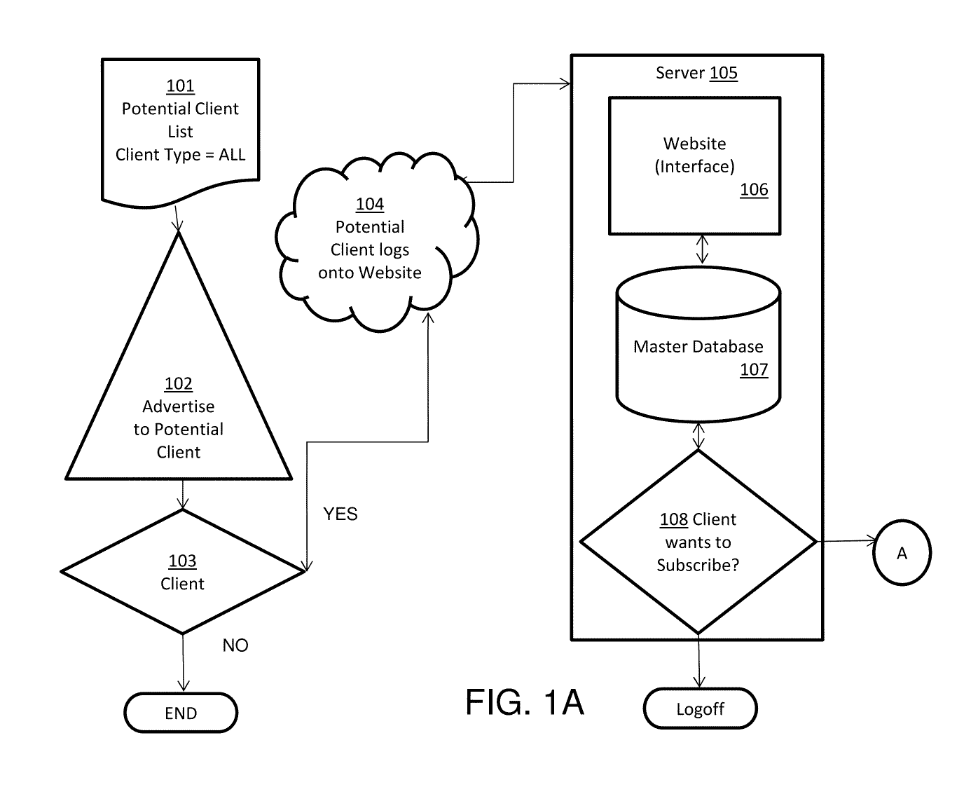

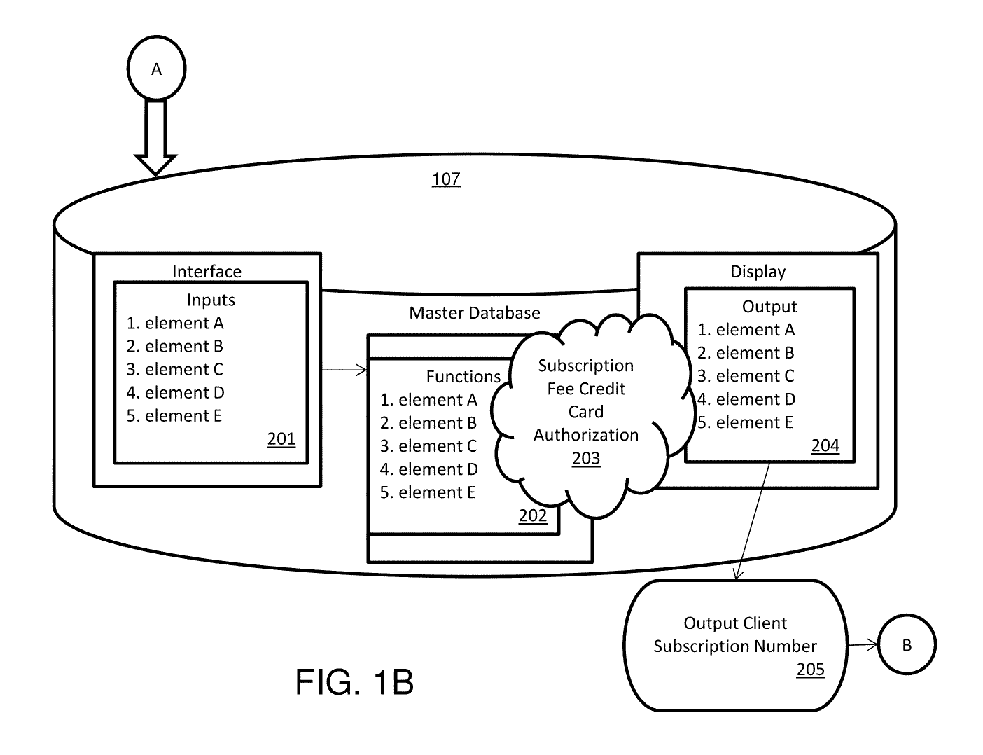

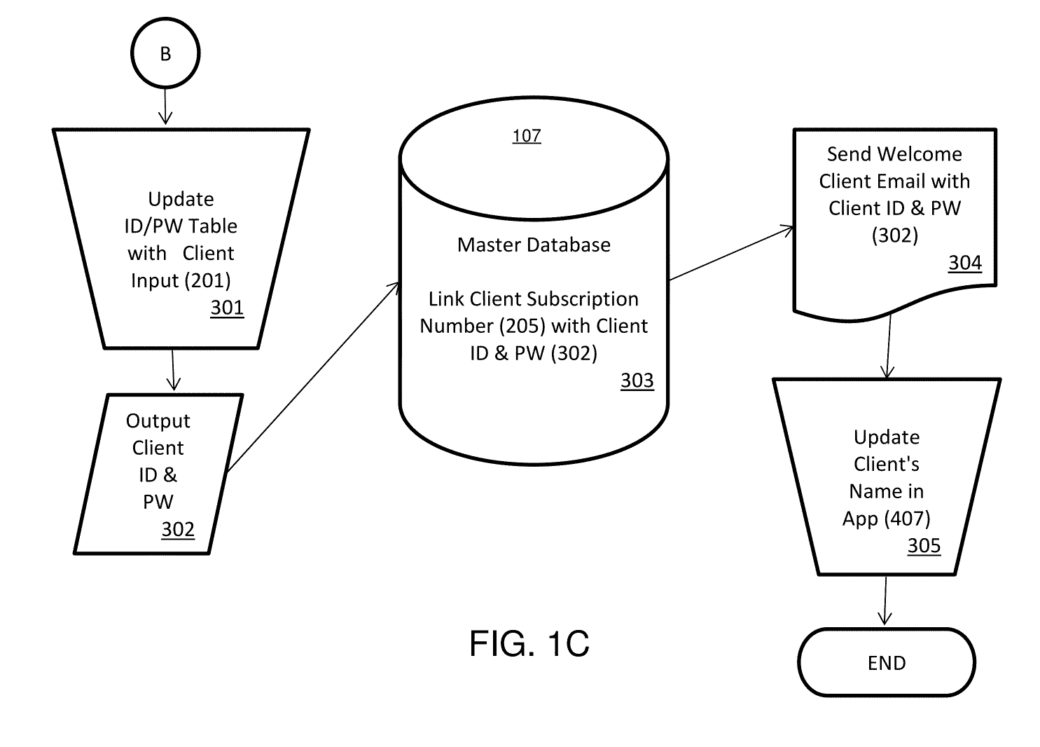

Referring now to the drawings, wherein like reference numerals designate identical or corresponding parts throughout the several views, and more particularly to FIGS. 1A-1C thereof, there is illustrated a system and method for real-time image aggregation from multiple contributors into one view, including client subscription. In FIG. 1A, a master potential client marketing list 101 is created and advertised to a potential client at step 102. At step 103, an interested client can log onto a website at step 104 via a web server 105 to interface within a website 106 hosted on the web server 105. The web server 105 includes a master database 107 for storing relevant subscription information, buying decision, and the like, at step 108.

FIG. 1B illustrates how the client subscribes. In FIG. 1B, the client accesses the master database 107 and inputs relevant information at step 201 that is processed via suitable program logic at step 202, for example, including a credit card routine, and the like, to pay a subscription fee, and the like, at step 203. The resulting output at step 204 can include a client subscription number, and the like, at step 205.

FIG. 1C illustrates client setup in a suitable application, including identification (ID) and password (PW) setup. In FIG. 1C, the client input from step 201 is used in creation of a unique ID and password at step 301. The created ID and password is then logged in an ID/PW table at step 302, and then in the master database 107. Step 303 then links or associates the client subscription number from step 205 with the newly created ID and password from step 302. Now with such unique identifiers, an email at step 304 is sent to the client advising the client of their ID and password. At step 305, the client information is updated in the application.

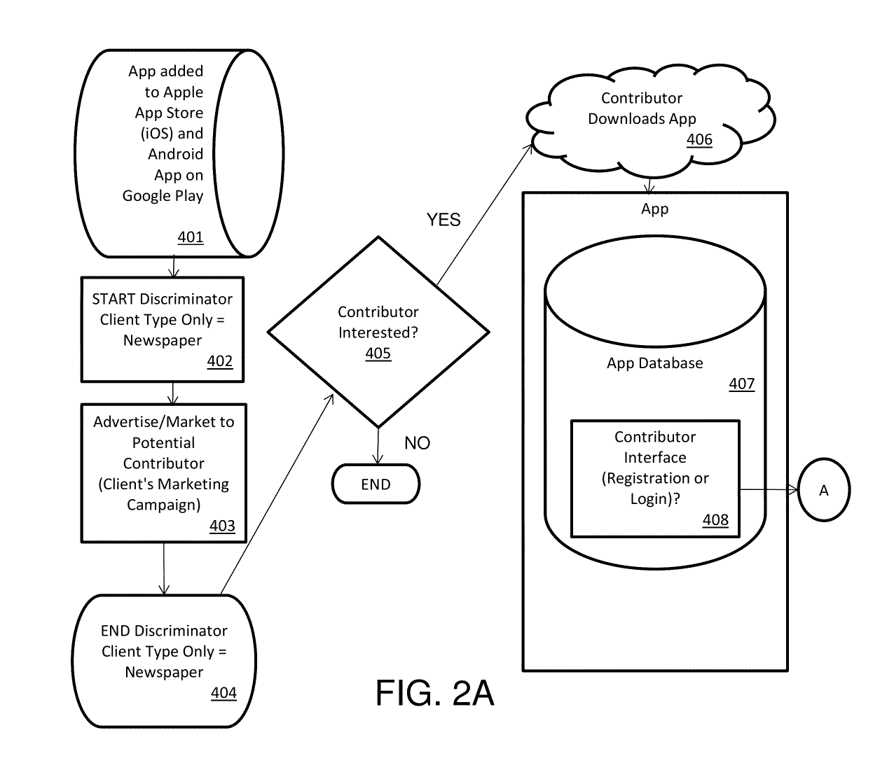

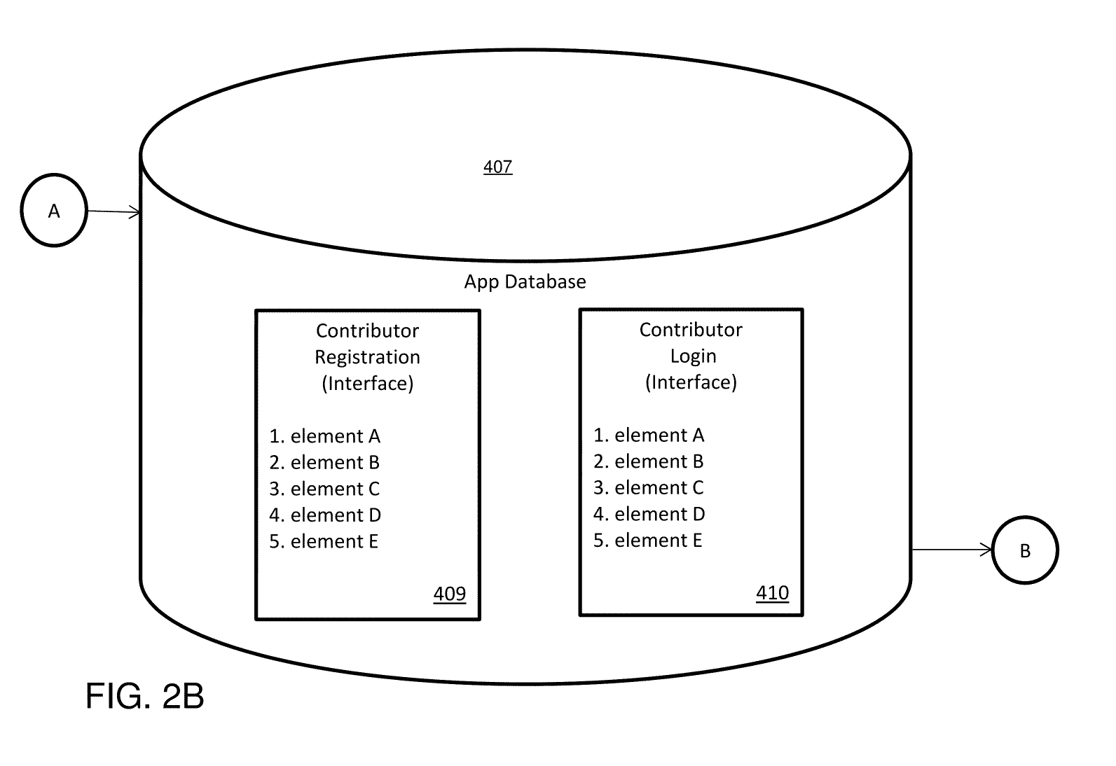

FIGS. 2A-2B are used to illustrate a system and method for real-time image aggregation, including contributor targeting. In FIG. 2A, the application, for example, is added to Apple App Store (iOS), as Android App on Google Play, and the like, at step 401. A suitable discriminator can be used to identify clients in the news industry at step 402. The news industry client can market/advertise to potential contributors starting at step 403, ending news industry discriminator at 404. Once a contributor is interested, at step 405, the contributor downloads the application at step 406, and enters suitable information at step 408 into the application database at step 407, for example, via suitable registration or login steps, and the like. FIG. 2B illustrates how a contributor accesses to the application via a registration step 409 or login step 410. Depending if the contributor is a first time user or not, the application at step 407 can display suitable screens.

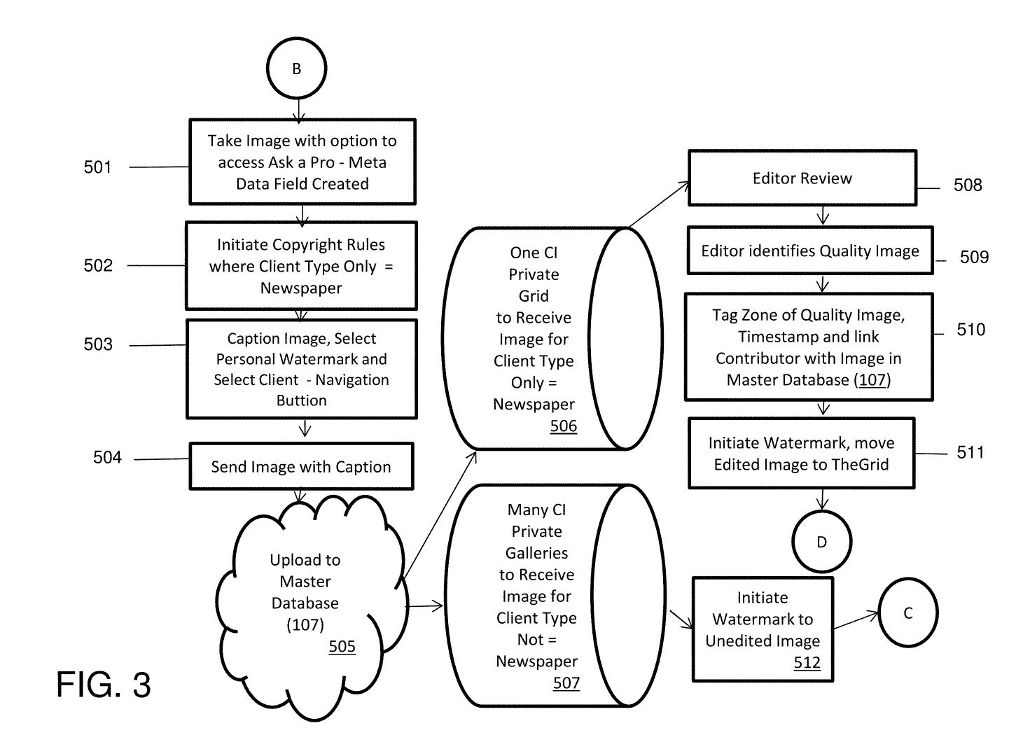

FIG. 3 is used to illustrate a system and method for real-time image aggregation, including upload of an image via an application. In FIG. 3, the contributor is able to take an image with the option to access an “Ask a Pro” function at step 501, for example, for providing tips on how to capture a quality image, and the like. Once the image is captured, suitable copyright rules are initiated at step 502. Each image can employ, for example, metadata fields, and the like, that store unique information (e.g., image name, timestamp, size, pixel count, other image information, etc.) about the image, thus, allowing the contributor to upload more than one image under a caption and/or independently caption each image for batch submissions, for example, employing multiple File Transmission Protocol (FTP) locations, and the like, at step 501. The contributors then selects a client, caption, personal watermark, and the like, at step 503, and the image with caption is sent at step 504 and uploaded at step 505 into the master database 107.

Even after the image is uploaded with a caption, and the like, the contributor can retrieve the caption, for example, by date and headline, and the like, to provide additional information about the image at step 501. Many contributors can upload images, in real-time, to a “grid” of a client, wherein a “Customer Type” denotes which client grid the image is uploaded. For example, if client type equals newspaper at step 506, an editor can perform review at step 508, identify a suitable quality image at step 509, tag the identified image with an originating zone and confirm the time the image is received at step 510. At step 511, the edited image is moved to the grid and a unique identifying security mechanism, watermark, and the like, is associated with the image at step 512. If client type does not equal newspaper at step 507, the image is uploaded to a “private” grid of the client, and a unique identifying security mechanism, watermark, and the like, is associated with the image at step 512. The contributor is able to use a navigation button to transmit the destination option at step 503.

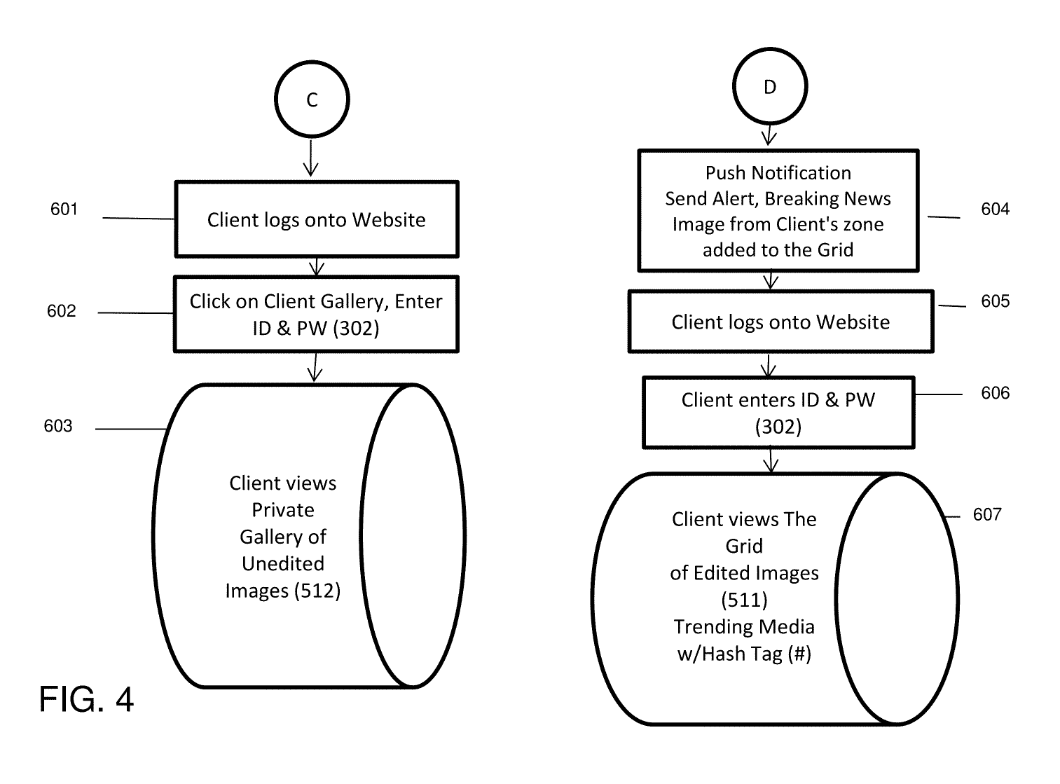

FIG. 4 is used to illustrate a system and method for real-time image aggregation, including an organization viewing an image. In FIG. 4, the client logs onto the website at step 601, clicks on their gallery at step 602, and views their private gallery of images at step 603. For clients in the news industry, a push notification at step 604 is sent alerting of a community news image from your zone having been added to the grid, after which the client logs onto the website at step 605, enters their ID and password at step 606, and views edited images at step 607. Trending media, and the like, can also be displayed via hashtags, and the like, at step 607.

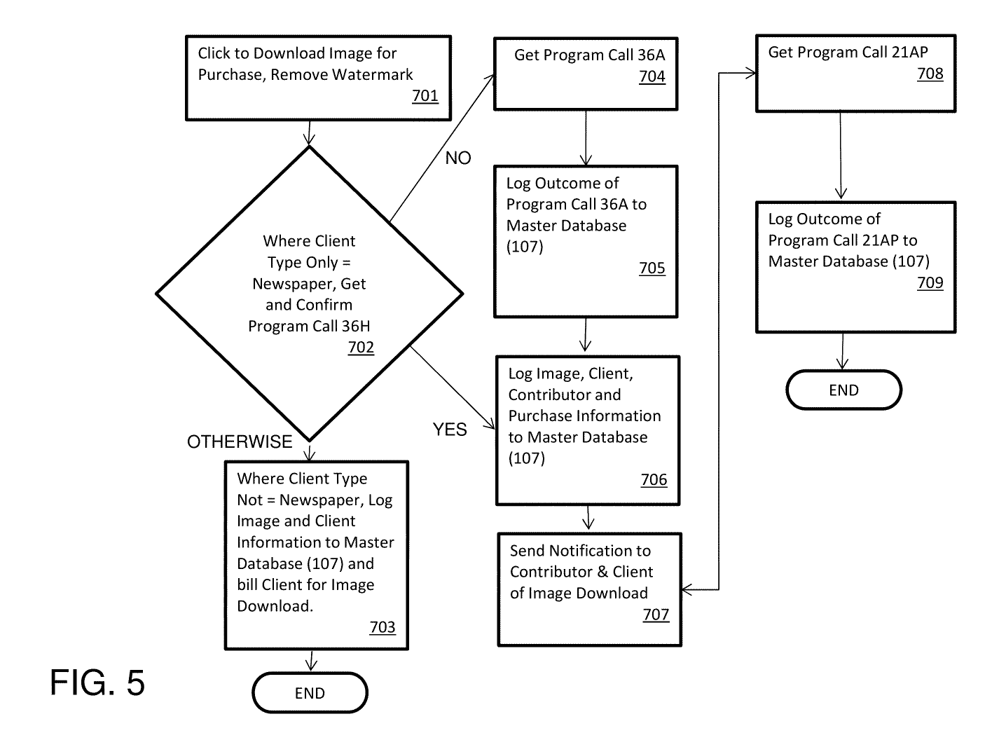

FIG. 5 is used to illustrate a system and method for real-time image aggregation, including purchasing of an image. In FIG. 5, at step 701, the client clicks on an image to download the image, which removes the watermark and initiates a checkout routine. If the client is not in the news industry, as determined by step 702, logging of the image and client information to the master database 107 is performed at step 703, and the client is billed for image download.

If the client is in the news industry, a trigger initiates a routine 702 to confirm program call 36H to check if purchase is less than or greater than predetermined purchase window. If less than predetermined window, the purchase information 706 is updated in the master database 107. If greater than predetermined window, a trigger initiates a pricing algorithm program call 36A based on current supply and demand variables for that image 704 and logs the outcome 705 of program call 36A to the master database 107. In either instance of an image purchase less than or greater than the predetermined purchase window, a notification is sent to the contributor and the client's accounts of the image download 707 and program call 21AP which is the affiliate program 708 updates master database 107 with the contributor's monetary share and the client's credits to purchase more images 709 each time a subscribing client purchase images from each other's contributors. An illustrative implementation of the application graphical user interface is shown in the following figures.

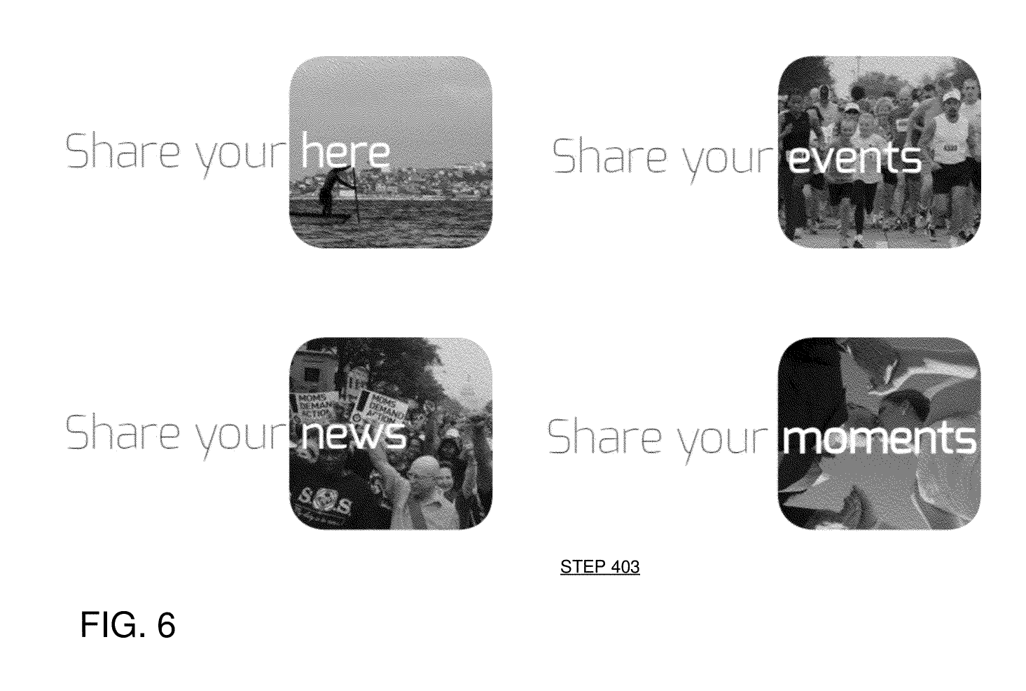

FIG. 6 is used to illustrate a system and method for real-time image aggregation, including a graphic example of marketing/advertising, and the like, to potential contributors, and the like. FIG. 6, for example, corresponds to FIG. 2A at step 403.

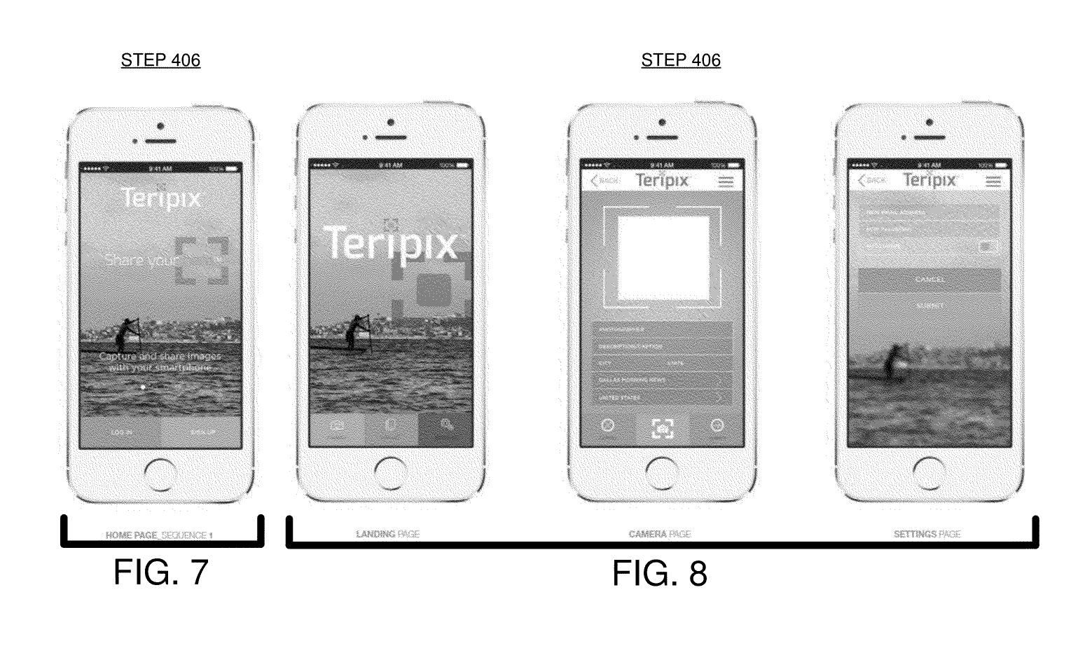

FIG. 7 is used to illustrate a system and method for real-time image aggregation, including a graphic example of the application downloaded on a cellular telephone. FIG. 7, for example, corresponds to FIG. 2A at step 406.

FIG. 8 is used to illustrate a system and method for real-time image aggregation, including additional graphic examples of the application downloaded on a cellular telephone. FIG. 8, for example, also corresponds to FIG. 2A at step 406.

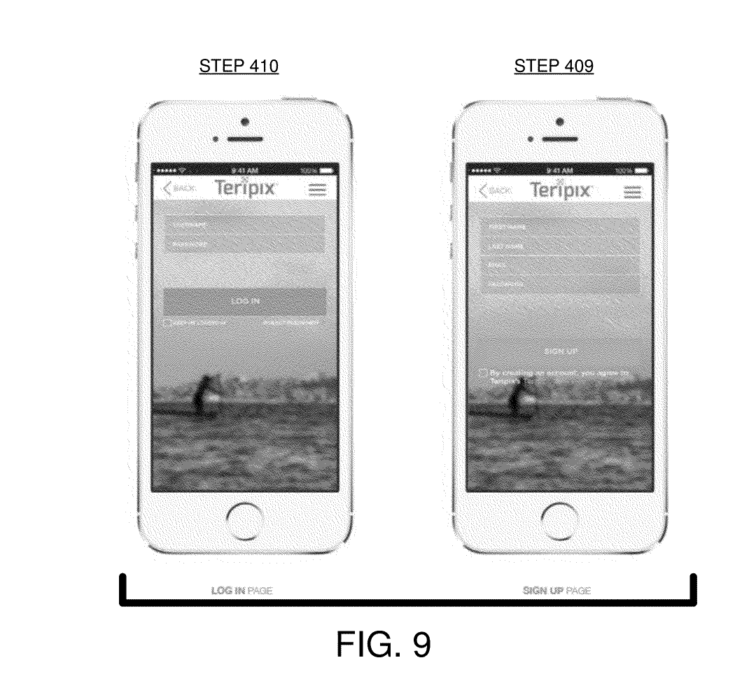

FIG. 9 is used to illustrate a system and method for real-time image aggregation, including a graphic example of a contributor accessing the downloaded application via login step 410 or registration step 409 as shown on FIG. 2B.

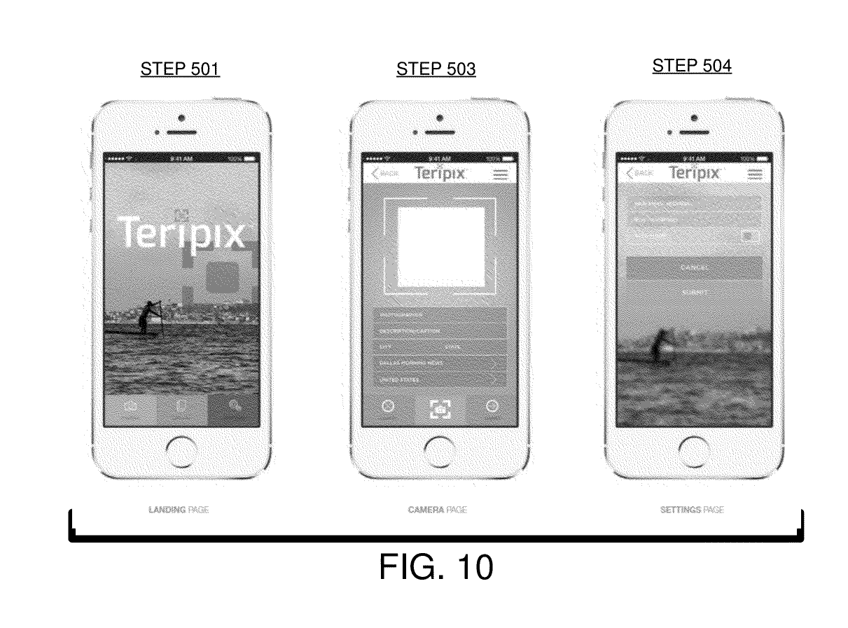

FIG. 10 is used to illustrate a system and method for real-time image aggregation, including a graphic example of a contributor using a cellular telephone to upload an image. FIG. 10, for example, corresponds to FIG. 3 at steps 501-504.

As previously described, simultaneous transmissions, for example, through multiple FTP sessions, and the like, applied to each photo can be employed, as will be appreciated by those having ordinary skill in the relevant art(s).

In further illustrative embodiments, video, moving pictures, and the like, can be employed based on the teachings of the present invention, as will be appreciated by those having ordinary skill in the relevant art(s).

The above-described devices and subsystems of the illustrative embodiments can include, for example, any suitable servers, workstations, PCs, laptop computers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the illustrative embodiments are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of illustrative embodiments, and implementations, the present inventions are not so limited, but rather cover various modifications, and equivalent arrangements, which fall within the purview of the appended claims.

What is claimed is:

1. A computer implemented system for embedding news agency specific information into an image data stream, the system comprising:
a server configured to process and route an image file according to information included in a data stream corresponding to the image file;
a cloud based database configured to transmit news agency specific information; and
a computer device including a software application configured to receive the news agency specific information from the cloud based database, embed the news agency specific information into the image file, and transmit the data stream corresponding to the image file to the server.

2. The system of claim 1, further comprising:
the news agency specific information configured to allow tracking of a news correspondent by a news agency for submission.

3. The system of claim 1, further comprising:
the news agency specific information configured to allow automatic routing of the image file.

4. The system of claim 1, further comprising:
the news agency specific information configured to allow tracking of payment tied to amateur correspondents submissions.

5. The system of claim 1, further comprising:
the news agency specific information configured to associate information in a cloud service to an image submission.

6. The system of claim 1, further comprising:
the software application configured to allow submission by an amateur correspondent, and consolidates news gathering image capabilities.

7. A computer implemented method for embedding news agency specific information into an image data stream, the method comprising:
processing and routing via a server an image file according to information included in a data stream corresponding to the image file;
transmitting via a cloud based database news agency specific information; and
receiving via a computer device including a software application the news agency specific information from the cloud based database, embed the news agency specific information into the image file, and transmit the data stream corresponding to the image file to the server.

8. The method of claim 7, further comprising:
allowing tracking via the news agency specific information of a news correspondent by a news agency for submission.

9. The system of claim 1, further comprising:
allowing via the news agency specific information automatic routing of the image file.

10. The system of claim 1, further comprising:
allowing via the news agency specific information tracking of payment tied to amateur correspondents submissions.

11. The system of claim 1, further comprising:
associating information in a cloud service to an image submission based on the news agency specific information.

12. The system of claim 1, further comprising:
allowing via the software application submission by an amateur correspondent, and consolidating of news gathering image capabilities.

13. A non-transitory computer program product having stored thereon a program that when executed by one or more computer processors cause the one or more computer processors to execute a method for embedding news agency specific information into an image data stream, the method comprising:
processing and routing via a server an image file according to information included in a data stream corresponding to the image file;
transmitting via a cloud based database news agency specific information; and
receiving via a computer device including a software application the news agency specific information from the cloud based database, embed the news agency specific information into the image file, and transmit the data stream corresponding to the image file to the server.

14. The computer program product of claim 13, further comprising:
allowing tracking via the news agency specific information of a news correspondent by a news agency for submission.

15. The computer program product of claim 13, further comprising:
allowing via the news agency specific information automatic routing of the image file.

16. The computer program product of claim 13, further comprising:
allowing via the news agency specific information tracking of payment tied to amateur correspondents submissions.

17. The computer program product of claim 13, further comprising:
associating information in a cloud service to an image submission based on the news agency specific information.

18. The computer program product of claim 13, further comprising:
allowing via the software application submission by an amateur correspondent, and consolidating of news gathering image capabilities.
